(19) United States
(12) Patent Application Publication
(10) Pub. No.: US 2022/0121175 A1
(43) Pub. Date: Apr. 21, 2022

(54) MACHINE SYSTEM

(71) Applicant: MULTIVAC SEPP HAGGENMUELLER SE & CO. KG, Wolfertschwenden (DE)

(72) Inventors: Guido SPIX, Ulm (DE); Marius GRATHWOHL, Senden (DE); Claus BOTZENHARDT, Kempten (DE); Thomas BAUR, Buchenberg (DE)

(73) Assignee: MULTIVAC SEPP HAGGENMUELLER SE & CO. KG, Wolfertschwenden (DE)

(21) Appl. No.: 17/502,331

(22) Filed: Oct. 15, 2021

(30) Foreign Application Priority Data
Oct. 16, 2020 (DE) 102020127282.0

(51) Int. Cl. G05B 19/4155

(52) U.S. Cl. CPC G05B 19/4155; G05B 2219/45048

(57) ABSTRACT

The disclosure relates to a machine system, in particular a packaging and/or processing machine, which comprises at least one input/retrieval device for inputting a first group of parameters of a complete set of parameters comprising the first group and at least a second group of parameters as adjustment parameters for operating the machine. The second group of parameters can be transmitted to the input/retrieval device from the Internet, where the number of and/or changes to the parameters of the first group can be selected/or determined via the Internet. As a result, a respective machine system is improved in such a way that a user of the machine system can be given limitations when adjusting his machine system in order, for example, to enable a usage and/or function-based billing model.

### CROSS-REFERENCE TO RELATED APPLICATIONS

This application claims foreign priority benefits under 35 U.S.C. § 119(a)-(d) to German patent application number DE 10 2020 127 282.0, filed Oct. 16, 2020, which is incorporated by reference in its entirety.

### TECHNICAL FIELD

The disclosure relates to a machine system, and in particular to a packaging and/or processing machine. The machine system can comprise one or more of these machines, where a machine system is also a series of packaging or processing machines or other machines.

### BACKGROUND

A corresponding machine system is described, for example, in DE 10 2017 130 111 A1. The machine system comprises a packaging machine which, inter alia, comprises a machine control device and an input/retrieval device. The input/retrieval device is configured as a graphical user interface on a display device for displaying parameters, that serve as adjustment parameters to operate the respective machine system, to the operator or for the latter to change them. There is the possibility that required visualization software is downloaded from the Internet and in particular from a cloud and displayed as a corresponding graphical user interface by the display device.

Furthermore, a corresponding machine system and in particular a packaging machine is known from WO 2017/021556. The respective packaging machine comprises a so-called recipe generator which comprises a set of rules for determining recipe variables for an adjustment process of the packaging machine and is configured in particular to generate recipe variables from a large amount of information relating to a product to be manufactured, to a packaging type for the latter, to at least one tool used in the packaging machines, etc., and to form a recipe data record therefrom for an adjustment process of the packaging machine. The recipe generator is, for example, integrated into a server or cloud system and for an adjustment process can be connected to a process parameter generator of a control unit of the packaging machine.

In view of the prior art mentioned above, the present disclosure is based on the object of improving a corresponding machine system in such a way that a user of the machine system is given limitations when adjusting his machine system in order, e.g., to enable a usage and/or function-based billing model

### SUMMARY

According to the disclosure, the parameters of a set of parameters, which comprises the adjustment parameters for operating the machine system, are subdivided into a first group and a second group of parameters. The respective input/retrieval device of the machine system is used to input the first group of parameters while the second group of parameters can be transmitted to the input/retrieval device from the Internet and where the number of and/or changes to the parameters of the first group can be selected and/or can be determined via the Internet.

This means that the second group of parameters or the selection and determination of the first group of parameters, respectively, is carried out, e.g., by the manufacturer of the machine system. This serves to implement a respective usage-based and/or function-based billing model. Such a billing model is particularly advantageous in the case of rented or leased machine systems that are only intended to be employed in a certain way by the operator of the machine system. There is, e.g., the possibility of respective billing of the use of the machine system per cycle executed for every packaging produced, and/or based on the consumption of packaging materials, and/or based on the consumption of labels, and/or based on comparison-based key variables. The respective billing can also be function-based, i.e., payment is effected per number/frequency of functions used on a machine, per number/frequency of processes used on such a machine, or also based on respective performance per packaging and per minute, or packaging output per day/week or month.

This means that the user of the machine system can be given a respective specification by way of the second group of parameters for using the machine system or the ability to select and/or predetermine the first group of parameters directly from the Internet. This means that the operator can use the first group of parameters e.g., to only change a few adjustment parameters by way of the input/retrieval device, while the other adjustment parameters, i.e., the second group of parameters, can be determined via the Internet or a respective cloud, taking into account the first group of parameters, and made available to the operator of the machine system. The complete set of parameters for operating the machine arises only from the first group of parameters and the second group of parameters. It is therefore possible to limit the number of parameters in the first group of parameters, i.e., the parameters that can be set at the input/retrieval device on the machine itself, or possibly to limit the respective changes or adjustments to the respective first group of parameters. These limitations relate, for example, to the permitted usage of the respective machine system as explained above, see number of cycles executed, number of material packages produced and the like.

It is there furthermore advantageous to have the machine system be usable only to a limited extent or be switched off in the absence of an Internet connection. This means that, as a rule, the machine system can be operated only with a permanent Internet connection and without such an Internet connection can only be operated to a limited extent or not anymore. The limited operability can consist in the fact that the machine system can only provide a predetermined performance and/or can only be operated using certain packaging materials and/or labels.

It can further be regarded to be favorable to have input pages, which can in particular be downloaded from the Internet from an external server, be displayable on the input/retrieval device in the presence of an Internet connection. These specific input pages are loaded by using a web browser of the input/retrieval device and used to enable interaction with the machine system as well as to initially determine or change adjustment parameters of the machine control device.

It can be regarded as a further advantage to have the parameters of the second group be usable for interacting with the machine and/or for selecting or changing the parameters of the first group. This means that in this case the second group of parameters is used directly to select or change the first group of parameters or for specific interaction with the machine system, e.g., to create or change machine settings.

It can also prove to be advantageous to have the parameters of the second group define a use of the machine system. Such use relates, e.g., to a certain number of packages produced, to a certain number or frequency of a function fetch, and the like. This means that all uses or functions of the machine system are substantially determined by the parameters of the second group.

It can also be considered to be advantageous to have an interaction with the machine system or the adjustment values of a machine control device be determinable or parameters of the first group be changeable using input pages. These input pages are respectively downloaded from an external server from the Internet. The external server can be associated with the manufacturer of the machine system. This means that only certain parameters can be selected or changed by the user of the machine system through the specific input page. They are the parameters of the first group of parameters.

It is there further to be noted that e.g., no such further settings can be created or changed without an Internet connection, see also the explanations above.

It can also be advantageous in this context to have the input pages be instanced or can be updatable, in particular locally. This means that input pages are time-limited as required when operated without an Internet connection, i.e., they are locally instanced, although the input pages can also be updated for operation with an Internet connection in order to enable new settings or functions or to deactivate settings or functions of the machine system.

It is also possible that the parameters of the first group can be calculated and/or determined as a function of the parameters of the second group.

Furthermore, it can be advantageous if changes to the adjustment parameters of the machine system are limited by the input/retrieval device and, in particular, cannot be changed without an Internet connection. This accordingly ensures a usage or function of the machine that is permitted for the user of the machine system, as already stated above.

It can also be advantageous in this context if the machine system is switched on for a predetermined time and/or usage and switched off in the absence of feedback from the Internet. This means that the machine system is stopped e.g., after a predetermined time or usage, see, for example, a certain number of packages produced or a certain number or frequency of a function fetch, without respective feedback from the Internet, where this can take place after a time period that is predetermined accordingly.

In order to store this accordingly also on the side of the machine system, there is the option that the machine system comprises a license module, for example, in the machine control device and/or in a separate control module, for providing a previously determined limitation of time or usage, and information on predetermined operating resources is stored in the license module or on the Internet. This means that the predetermined time or usage is stored as a license module in the machine control device or in a separate control module of the machine. This separate control module can be, for example, a so-called edge device which is used e.g., to access a respective network of a service provider, such as of the machine system manufacturer. This means that the machine can continue to produce without changing the respective adjustment parameters until the predetermined time or predetermined usage has elapsed and the machine system is, e.g., stopped only after a usage predetermined accordingly, see, for example, a certain number of packages produced, a certain number or frequency of a function fetch or the like.

As already described above, it has proven to be advantageous in this context to have the adjustment parameters or parameters of at least the first group of parameters not be changeable until the machine system has been switched off. This unchangeability relates to a respective change, possibly by the user of the machine system, directly by way of the input/retrieval device.

This can prevent the machine system from being employed for other usage or functions. Furthermore, it can be advantageous in this context if the release of the machine system can be performed by an external server via the Internet, in particular in an automated manner. This means that, after a respective switch-off, the machine system can be released only externally, i.e., by way of a connection to or query from the machine control device or from the control module of the machine system with a defined data end point on the external server in that e.g., the respective license module is synchronized with the external server.

It is there further advantageous if, after a predetermined time and/or a predetermined usage of the machine system, the latter is switched to a sleep mode, in particular by restoring adjustment values of the machine system to an initial state and/or by blocking a sequence control of the machine system. This means in particular that the machine system then sets all respective adjustment values or sets all to “0” and/or the sequence control system at the machine system is locked and/or further changes to machine settings are prevented by displaying a lock screen on the input/retrieval device through modified authorization and control after e.g., a certain number of packages, a certain number or frequency of a function fetch at the machine system or the like without feedback from the Internet, and the machine switches to a safe mode to prevent injuries and danger to an operator. The time predetermined in this context or the usage components predetermined are stored accordingly as a license module in the machine control device or a separate control module of the machine. There is also the option that the machine system is limited to a certain number of functions or processes, or pertains to a certain number of functions or processes e.g., a certain number of packages that are produced by the machine system, the execution of a certain number of cycles, or the number or frequency of fetches for functions or processes at the machine system. It is further advantageous to have the machine system comprise a logging device for logging, possibly with a time stamp, in particular for usages of the machine system, where the logging results can be transmitted to an external server. This means that the machine system logs a correspondingly defined usage indicator, e.g., packages, cycles, functions, processes or the like and sends that together with a time stamp of an Internet-based, in particular recognized, time server to the external server.

There is also the possibility that respective previously defined additions to e.g., usage, see, e.g., packaging, cycles, functions, processes and the like, are stored as a license module at the machine system or in a separate control module of the machine system and the machine constantly compares the respective information of the license module with the respective usage log—even without an Internet connection—and stops the machine when an allowable usage limit has been exceeded.

It can also prove to be advantageous in this context to also have stored in the machine control device that the machine can only be operated with defined packaging materials, labels, or other operating resources, in that packaging materials, labels, or other operating resources can clearly be recognized and identified by the machine, see e.g., RFID technology or sensor-based detection of film material or also optical detection of unique identifiers, such as QR codes. Such information about the operating resources allowed on the machine system, see packaging materials, labels, or other operating resources, can also be stored as part of the license module at the machine system or in a separate control module of the machine system. If an operating resource is changed, then the machine system can compare the new operating resource with the operating resources stored and approved in the license modules and stop the machine system if the new operating resource used does not correspond to one stored in the license module. Furthermore, there is the option that the operator of the machine system is granted a defined price advantage e.g., by the machine system manufacturer when using the machine, provided that he only uses operating resources that are stored in the license module.

A further advantage could be that a new license for using the machine system can be downloaded from the license module or loaded thereinto. This means that the operator of the machine system e.g., can acquire a new license by way of the input/retrieval device and it can be stored accordingly with license modules. The license can be acquired e.g., using a customary form of payment, such as credit card or the like. Such acquisition of a new license can also be possible e.g., in offline operation of the machine system, in which case the license module with the stored new license is then synchronized with the external server in the respective online operation.

According to the disclosure, a new type of machine system results overall which comprises different set of parameters, where one of these sets of parameters is used to enable a specific billing model for use of the machine system. This billing model is usage-based and/or function-based, as described above, and can relate to renting or leasing the machine system. The various sets of parameters make it possible, e.g., for the lessor or leaser to request corresponding payment in relation to the usage of the function and number/frequency of machine processes executed. Furthermore, the user of the machine system is not able to continue operating the machine, to operate it in any other way, or to use it e.g., with other resources, without a respective Internet connection and feedback via the Internet. Overall, the machine system is monitored by the lessor or leaser, which means that the entire billing model can be carried out efficiently and the user of the machine system has little opportunity to employ and use the machine system outside of the predetermined license.

### BRIEF DESCRIPTION OF THE DRAWINGS

The disclosure shall be explained in more detail below with reference to the FIGURE appended in the drawing.

FIG. 1 shows a basic illustration of a machine system according to the present disclosure.

### DETAILED DESCRIPTION

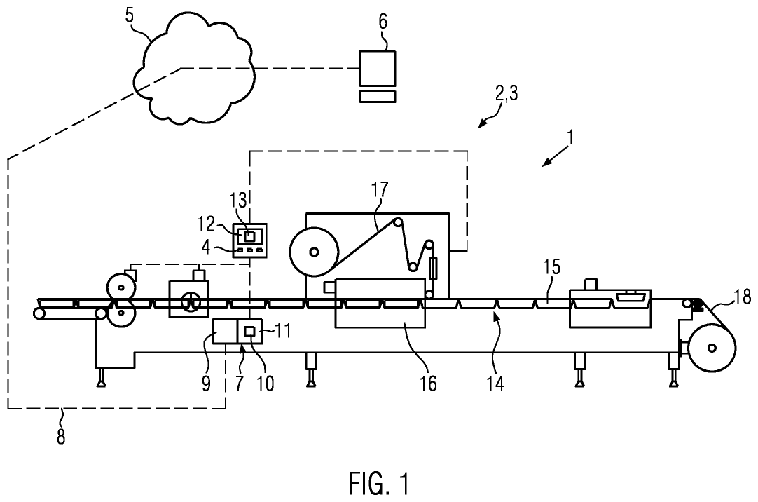

FIG. 1 shows a lateral schematic representation of a machine system 1, in this case a packaging machine 2. It is to be noted, however, that the disclosure relates not only to an individual packaging machine, but also to a series of machines forming a system or line of several machines, such as. e.g., packaging and processing machines and the like.

Packaging machine 2 shown in FIG. 1 comprises e.g., a base film 18 which is supplied from a roll and from which a number of packaging parts 15 are formed. They are moved along a loading stretch 14 in which a product is placed into packaging parts 15. A top film 17 also from a respective roll is sealed on in a chamber 16, so that, overall, a closed package with a product disposed therein is transported onward. The respective packagings are then separated from one another and transported onward. Packaging machine 2, which can also be a respective processing machine 3, forms part of respective machine system 1. Packaging machine 2 is associated with a machine control device 7 which comprises a logging device 9 and e.g., a license module 10 as part of the machine control device or as a separate control module 11. Packaging machine 2 also comprises an input/retrieval device 4 with visualization software 12 for displaying input pages 13. Packaging machine 2 and in particular machine control device 7 are connected to Internet 5 via an Internet connection 8 to which an external server 6 is also connected.

To operate the machine system or the packaging machine shown in FIG. 1, a number of adjustment parameters is required which, according to the disclosure, comprises at least two groups of parameters. A first group of parameters can be entered at the input/retrieval device. A second group of parameters is transmitted from the Internet, where the first group of parameters and the second group of parameters then form a complete set of parameters which as a whole comprises the adjustment parameters necessary for operating the machine system.

The first group of parameters comprises some parameters that can be entered by a user of the machine system at input/retrieval device 4, where this input/retrieval device comprises e.g., respective input pages 13 as part of a visualization software 12. The corresponding visualizations can be downloaded from the Internet or the cloud in the form of HTML pages and the first group of parameters can then be entered accordingly. However, the complete set of parameters for operating the machine system arises only together with the second group of parameters. The number of and/or change to the first group of parameters can optionally be adjustable or limited and an input of the first group of parameters can be deactivated, in particular, in the absence of an Internet connection, so that the machine system is possibly only usable to a limited extent or is also switched off. This can take place, e.g., after a predetermined time without feedback from the Internet so that the machine control device only stops the machine system after this predetermined time. Renewed release of the machine system is not possible without feedback from the Internet, but can only take place online e.g., by an external server 6 via Internet 5 and accordingly via an Internet connection 8. Furthermore, the respective deactivation of the machine system can take place not only when it is offline, but possibly also in dependence of a license verification by way of a respective license module 10 which is part of machine control device 7 or of a separate control module 11. This implements a so-called pay-per-use billing model, whereby it is possible e.g., to use the machine system for a limited time, only for certain usage or number of uses, certain processes or the like. In addition, this pay-per-use billing model defines the number of cycles executed, of packagings produced, the consumption of operating resources and the like. Corresponding payment can therefore be calculated on the basis of the respective usage, functions used, or number/frequency of processes of the machine system executed. The fact that the machine system can only be operated with an existing Internet connection, so that the machine system is no longer operational or is only operational to a limited extent without a corresponding Internet connection serves this purpose. The limited operability can be constituted, for example, by the fact that the machine system can only be operated with a previously defined output and/or only with predetermined operating resources. According to the disclosure, a respective input page is displayed at the input/retrieval device as an HMI in dependence of the presence of the Internet connection and then only allow certain interactions with the machine system or only allow or prohibit certain changes to adjustment values, see first group of parameters.

According to the disclosure, the machine system can therefore only be used if both sets of parameters are available, where machine settings are generally not able to be generated or changed without a respective Internet connection. According to the disclosure, the respectively permitted usage and the like of the machine system is only permitted as long as this is made possible by corresponding license module 10. The respective usage options are stored in this license module both in temporal terms as well as regarding their number and can possibly be extended or changed by the respective acquisition of a new license. The new license can also be acquired via the input/retrieval device.

Furthermore, the disclosure makes it possible for the lessor or leaser to determine in a simple manner whether maintenance is necessary, whether additional operating resources need to be delivered, whether possible failures of the machine system are to be expected, whereby respective outage times of the machine system or even downtimes are avoided to the extent possible. This means that there is also the possibility of recording consumption and other data in real time due to the respective connection of the machine system to the Internet and the use of the corresponding groups of parameters, as well as implementing new billing options for renting and leasing that are usage-based, function-based, or performance-based. Moreover, those skilled in the art will appreciate that any or all of the devices, modules, and/or systems 4, 7, 9 10, and 11 and/or any other unit, system, or device described herein may comprise, in whole or in part, a combination of analog and digital circuits, such as one or more processors configured with software and/or firmware, e.g., stored in a memory, that when executed by the one or more processors perform the functions and/or operations described herein. One or more of such processors, as well as other digital hardware, may be included in a single ASIC (Application-Specific Integrated Circuitry), or several processors and various digital hardware may be distributed among several separate components, whether individually packaged or assembled into a SoC (System-on-a-Chip).

What is claimed is:

1. A packaging and/or processing machine system, comprising at least one input/retrieval device for entering a first group of parameters of a complete set of parameters comprising the first group and at least one second group of parameters as adjustment parameters for operating the machine system, where the second group of parameters can be transmitted to the input/retrieval device from the Internet, and where the number of and/or changes to the parameters of the first group can be selected and/or can be determined via the Internet.

2. The machine system according to claim 1, where the machine system is usable only to a limited extent or is switched off in the absence of an Internet connection.

3. The machine system according to claim 1, where input pages downloadable from the Internet or from an external server are displayable on the input/retrieval device in the presence of an Internet connection.

4. The machine system according to claim 1, where the parameters of the second group can be used for interaction with the machine system and/or for selecting or changing the parameters of the first group.

5. The machine system according to claim 1 where the usage of the machine system is determined by the parameters of the second group.

6. The machine system according to claim 1, where an interaction with the machine system or the adjustment values of a machine control device can be determined or parameters of the first group can be changed using input pages, where the input pages are locally instanced or updated.

7. The machine system according to claim 1, where the parameters of the first group can be calculated and/or determined as a function of the parameters of the second group.

8. The machine system according to claim 1, where changes to the adjustment parameters of the machine system by way of the input/retrieval device are limited and cannot be changed without an Internet connection.

9. The machine system according to claim 1, where the machine system is switched on for a predetermined time and/or usage and can be switched off in the absence of feedback from the Internet.

10. The machine system according to claim 1, where the machine system comprises a license module and/or a separate control module for providing a previously determined limitation of time or usage, and information on predetermined operating resources are stored in the license module or control module or on the Internet.

11. The machine system according to claim 1, where the adjustment parameters or parameters of at least the first group of parameters cannot be changed until the machine system has been switched off.

12. The machine system according to claim 1, where the machine system is to be released via the Internet after having been stopped or switched off, where the machine system can be released in an automated manner by an external server via the Internet.

13. The machine system according to claim 1, where, after a predetermined time and/or a predetermined usage of the machine system, the machine system is switched to a sleep mode, in which the adjustment values of the machine system are restored to an initial state and/or a sequence control system of the machine system is blocked.

14. The machine system according to claim 1, where the machine system is limited to a certain number of functions or processes.

15. The machine system according to claim 1, where the machine system comprises a logging device for logging with a time stamp for usages of the machine system, where the logging results can be transmitted to an external server.

16. The machine system according to claim 1, where a new license for using the machine system can be downloaded from a license module.

17. A packaging and/or processing machine system comprising an input/retrieval device for entering a first group of parameters of a complete set of parameters comprising the first group and a second group of parameters, the second group of parameters being adjustment parameters for operating the machine system, where the second group of parameters are transmittable to the input/retrieval device from the Internet, and where the number of and/or changes to the parameters of the first group can be obtained via the Internet.

18. The machine system according to claim 17, where the machine system switches off in the absence of an Internet connection.

19. The machine system according to claim 17, where the usage of the machine system is determined by the parameters of the second group.
